(19) United States
(12) Patent Application Publication
(10) Pub. No.: US 2003/0018697 A1
(43) Pub. Date: Jan. 23, 2003

(54) Apparatus and method for workflow

(76) Inventors: Maurice Haman Abraham, Reading (GB); Eric Joseph Stammers, Guildford (GB)

Correspondence Address: c/o LADAS & PARRY, Suite 2100, 5670 Wilshire Boulevard, Los Angeles, CA, 90036-5679, US

(21) Appl. No.: 10/005,898

(22) Filed: Nov. 2, 2001

(30) Foreign Application Priority Data
Jul. 18, 2001 (GB) 0117558.7

(51) Int. Cl. G06F 15/16

(52) U.S. Cl. 709/201

(57) ABSTRACT

A computer apparatus for implementing a workflow, the workflow being defined by a sequence of activity nodes that include a plurality of interactive nodes, the computer apparatus comprising a processor for arranging and initiating the execution of the activity nodes in accordance with the defined sequence, wherein each interactive node is arranged to allow a user to input data for use in the execution of an activity node, the processor being arranged to analyse the user data to determine the interactive node in the sequence of activity nodes to which the data is associated.

### TECHNICAL FIELD

The present invention relates to an apparatus and method for implementing a workflow.

### BACKGROUND ART

To achieve increased levels of quality, throughput and service at reduced costs individuals and companies are placing an increasing emphasis on automation and computer controlled processes.

In particular, workflow systems (i.e. process management packages) are particularly useful for controlling processes that are definable and governed by a series of policies and procedures, for example insurance claim processing, mortgage loan processing and engineering change orders. Accordingly, the use of workflow systems is increasing in popularity.

Workflow systems are based on procedure definitions that define which process activities must be performed and the sequence in which the activities must be performed.

The procedure is defined using activity nodes connected via arcs, which represent activities of the procedure. Examples of activity node types are work nodes that typically perform, or initiate, a service and route nodes that are used to define the routing within the process. The activity nodes may incorporate rules that define entry conditions for the activity node and exit conditions that need to be checked after the activity node is completed.

Each performance of the workflow for a given procedure definition with associated data (for example, information provided during the running of the workflow) is called an instance.

Typically a user of a workflow system will be located remotely to the workflow engine, where the engine is responsible for the arranging and initiating the execution of the activity nodes in accordance with a defined sequence. The user will typically interface with the workflow engine via interactive activity nodes, for example when selecting optional extras in the purchase of certain goods. However, user interfaces, for example web browsers, do not operate synchronously with a workflow engine. Therefore, a user navigating through a sequence of interface pages (for example, using the forward and back buttons on a web browser) will not be synchronised with corresponding workflow engine interactive nodes. Correspondingly, the workflow engine can receive out of sequence responses from a user that can cause the workflow engine to crash or result in a process being incorrectly completed.

It is desirable to improve upon this situation.

### SUMMARY OF INVENTION

In accordance with a first aspect of the present invention there is provided a computer apparatus for implementing a workflow, the workflow being defined by a sequence of activity nodes that include a plurality of interactive nodes, the computer apparatus comprising a processor for arranging and initiating the execution of the activity nodes in accordance with the defined sequence, wherein each interactive node is arranged to allow a user to input data for use in the execution of an activity node, the processor being arranged to analyse the user data to determine the interactive node in the sequence of activity nodes to which the data is associated.

This provides the advantage of allowing internet based applications to interact with the workflow without requiring modification of the internet based applications.

Preferably the processor being arranged, in response to the analyse, to initiate execution of the associated interactive node such that if the user data is associated with an interactive node that has been executed the interactive node is re-executed.

Suitably the processor is arranged to compensate executed activity nodes that follow in the defined sequence from the re-executed interactive node.

Preferably the computer apparatus is coupled, via a network, to a second computer apparatus, the second computer apparatus having a user interface to allow a user to input data for an interactive node.

In accordance with a second aspect of the present invention there is provided a method for implementing a workflow, the workflow being defined by a sequence of activity nodes that include a plurality of interactive nodes, the method comprising arranging and initiating the execution of the activity nodes in accordance with the defined sequence, wherein each interactive node is arranged to allow a user to input data for use in the execution of an activity node, and arranging to analyse the user data to determine the interactive node in the sequence of activity nodes to which the data is associated.

### BRIEF DESCRIPTION OF DRAWINGS

For a better understanding of the present invention and to understand how the same may be brought into effect reference will now be made, by way of example only, to the accompanying drawings, in which:

FIG. 1 shows a computer system according to the present invention;

FIG. 2 shows a block diagram of workflow software according to the present invention;

FIG. 3 illustrates an example of a process definition.

### DETAILED DESCRIPTION OF DRAWINGS

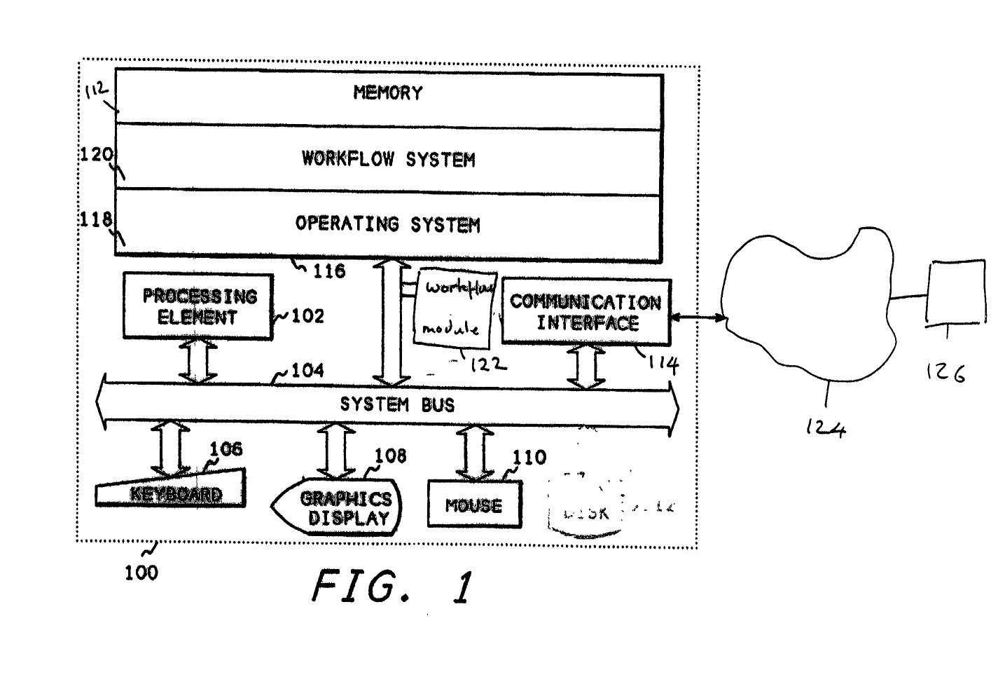

FIG. 1 shows a computer system suitable for implementing a workflow. Computer apparatus 100 is a conventional computer, as is well known to a person skilled in the art, which in this embodiment comprises a processor 102 that communicates with other elements of the computer apparatus 100 over a system bus 104. A keyboard 106 to allow data to be input into the computer apparatus 100 and a mouse 110 to allow graphical locator input into the computer apparatus 100. A graphics display 108 provides for graphics and text output to be viewed by a user of the computer apparatus 100. A memory 112 stores an operating system 118 and other data used by the computer system 100, for example workflow implementation details, as describe below.

Installed on the computer apparatus 100 is a workflow module 112 that is responsible for implementing a workflow, as described below.

The workflow module 112 can be operated directly, for example via keyboard 106 or agent software (not shown) loaded on computer apparatus 100. Alternatively, the workflow module 112 can be accessed via a remote user, for example using computer apparatus 126. Computer apparatus 126, a conventional computer well known to a person skilled in the art, is coupled to computer 100 via a network 124, for example a local area network (LAN) or the internet.

To allow communication between computer apparatus 100 and computer apparatus 126, computer apparatus 100 comprises a communication interface 114. Thus, to implement a workflow an agent (e.g. an individual person, a group of people, an application program or a physical machine) may use a single computer, or a remote computer connected through the communications interface 114.

Additionally, as described below, the communication interface can be used to accessing external service providers (not shown) for executing process activities associated with the execution of an activity node.

The workflow module 122 may be implemented as workflow software, alternatively however the workflow module 122 can be implemented in hardware or a combination of hardware and software.

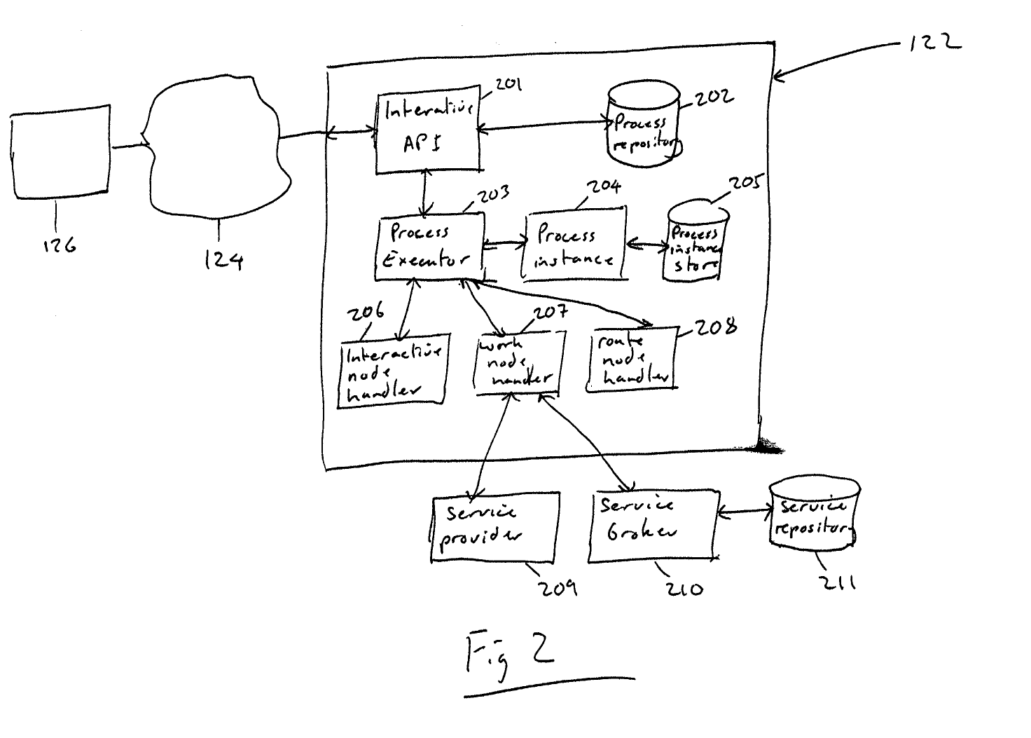

FIG. 2 shows a block diagram of workflow components associated with workflow modules 122. The Interactive application program interface 201 (API) is the primary access point for an agent. The interactive API 201 allows an agent (e.g. a client application) to interact with a workflow implementation being handled by the workflow module 122. The interactive API 201 allows an agent to, for example, obtain a description of the data required to start a workflow; start a new process instance; feed back data to interactive nodes (as describe below) to allow a workflow to continue execution; obtaining a final output of the process instance; querying the status of a process instance; intervening with a process instance.

Process repository 202 is a store of process definitions to allow an agent to select a particular workflow type to be implemented. In this implementation the process definitions are stored in extended mark-up language (XML) format. This can be stored in memory 112

Process executor 203 is the main logic module that controls the logic flow of a workflow. The process executor 203 uses a process definition with associated process instance to determine the sequence that a particular process should be implemented and controls this sequence. In this embodiment the process executor 203 is implemented in software, invoking appropriate node handlers to perform each step of a process definition. The process executor 203 controls the order in which nodes are executed and for transversing the arcs of a process definition (i.e. the links between the activity nodes associated with a process definition).

The process executor 203 is arranged to execute a process instance data when encapsulated in XML format. However, any suitable executable form could be used.

An activity node handler is responsible, in response to the process executor 203, for initiating the execution of a particular activity that forms part of a process definition. Examples of activity node handler types are: work node handler 207, route node handler 208 and interactive node handler 206.

A work node handler 207 is responsible for initiating the execution of a process activity that is external to the workflow module, where the activity is performed by an external service provider. An example of an external process would be the delivery of a product for a workflow associated with the purchase and delivery of a product.

To allow the work node handler 207 to obtain access to particular services in a process a service provider plug-in module 209 is provided. The plug-in module 209 can interface with an external service (not shown) via the communication interface 114. A variety of different service providers can typically be accessed to allow a variety of different services to be implemented. A service broker 210 can be provided to assist in the location of a suitable service provider from service definition information held in a process definition using a service repository 21 that contains a database of available service providers.

A route node handler 208 is responsible for deciding which subsequent arcs of a process definition should be fired thus determining which activity nodes should be performed.

An interaction node handler 206 allows an agent to interact with the workflow implementation, for example to allow a user to input require criteria for the implementation of the workflow. Where the workflow module is being accessed by an agent via the internet an interaction node can present to the agent a web page, thereby providing the agent the opportunity to input suitable data. For example, to allow an agent to purchase a car using a workflow, the workflow would typically contain an interactive node for providing the agent a web page to input details on the type of car required. The interactive node handler 206 uses a service interface (e.g. type of web page) that can be selected from a repository (not shown). The service interface is used to map data from the process instance into and from an extended mark-up language (XML) document, which will be used to communicate with the user via the interactive API.

Having a separate interaction node handler 206 allows the communication between the workflow implementation and an agent to be clearly articulated. Additionally, having a separate node type allows the interaction node handler 206 to permit a user to re-enter the process at a previous point. This facility is provided to support the common habit of web applications that allow the user to press the back button on an internet browser (not shown) and rewind their way back through the application as desired, as described below.

Process instance 204 is a record of the state of a workflow implementation, including the start time, end time, and the state of all activity node handlers. The process instance 204 additionally contains the logic in it to handle the invoking of the respective node handlers. The process instance 204 is created from an appropriate process definition and provided to the process executor 203 for execution of the workflow.

The process instance store 205 maintains a database of process instance data associated with the execution of workflows. The data can be stored in memory 112, as described below.

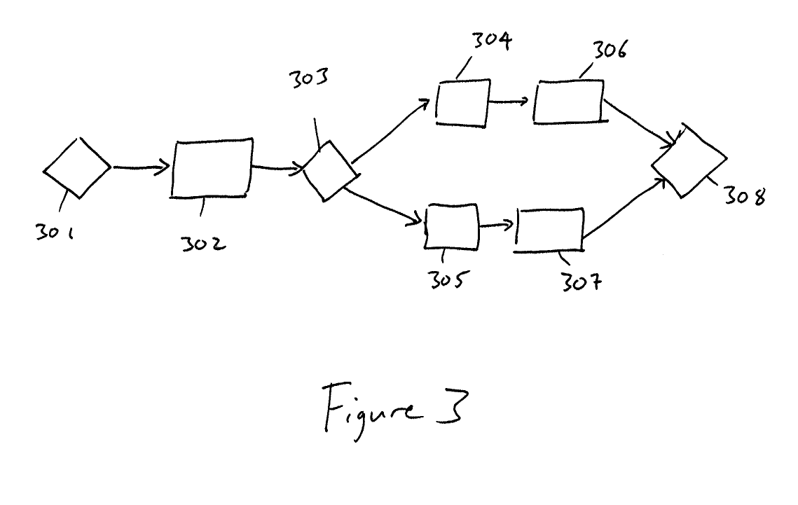

The process definition is a workflow map, where activity nodes are linked, via arcs, to define the sequence of activities in the workflow, as shown in FIG. 3. Within the process definition there are typically two ways an activity node can be executed, synchronous and asynchronous.

Execution of synchronous nodes is performed one at the time, per process instance (i.e. one particular performance of a procedure definition).

Route nodes are executed synchronously. Therefore, for a process definition having a parallel process of route nodes and synchronous work nodes, the nodes will be executed in the order that they are encountered.

For the execution of asynchronous activity nodes the node handler associated with the asynchronous node becomes free after the activity node has started but before the activity node process has yet completed. This allows the execution of the process definition to continue while the asynchronous node is being completed.

For example, the process definition shown in FIG. 3 comprises three route nodes 301, 303, 308 and five work nodes 302, 304, 305, 306, 307.

If the work nodes are all synchronous the activity nodes would be executed in the order of:

301, 302, 303, 304, 305, 306, 308, 307, 308

After the execution of route node 303, both work nodes 304 and 305 need to be started. First work node 304 is executed and work node 306 is noted as needing to be done. Next work node 305 is executed followed by work node 306. However, after work node 306 has executed, route node 308 is executed as route nodes have a higher priority than work nodes.

If the work nodes 304 and 307 are asynchronous the activity nodes would be executed in the order of:

301, 302, 303, start 304, 305, start 307

Then depending upon whether node 304 or node 307 completes first:

Finish 304, 306, 308, finish 307, 308 (if node 304 completes first)

or

Finish 307, 308, finish 304, 306, 308 (if node 307 completes first)

After the execution of node 303, both nodes 304 and 305 need to be started. Node 304 is started and node 305 is executed to completion. Then node 307 is started.

The process execution stops at this point while replies are waited for from asynchronous nodes 304 and 307.

Depending upon which reply arrives back first the sequence continues with:

304, 306, 308, 307 or 307, 308, 304, 306, 308

The state of an activity node in a process instance is defined by an activity node state. All activity nodes start off in a new state. Once an activity node has started to be executed it is active, when it completes its state it becomes completed. The activity node can have other states, for example failed, timed out.

If an activity node is reset, for example due to compensation (see below), the activity node's state is set back to new.

Node instance's contain information about a particular execution of the node and is include in the process instance. If there is a loop (with a reset arc) within the process definition, it is possible to have multiple node instances per node in the process instance. Each node instance has a start time, end time and undo time, as well as information on the changes made to the process data as a result of completion.

A process event (i.e. an event that can effect the way the process is executed, for example an order cancellation) when received by a process instance is stored and processed when the process instance is ready to process it.

The process definition can be created using a process definer (not shown) under the operation of a user. The process definer, typically a software application, maintains a list of activity node types and service capabilities for those node types. A user is able to define the sequence of execution of a selection of available activity node types to define a required workflow (i.e. work process), thereby creating a process definition. The process definition is created in an executable form, for example as an XML document.

The process definer can be configured to interface with the process repository 202 for loading into the process repository 202 process definitions and/or accessing and updated existing process definition within the process repository.

A workflow can be initiated by either sending a process start request to the interactive API 201 detailing the name of a process definition stored in the process repository 202 with associated starting data, or by sending a process start request with the process definition itself plus associated start data. For example, as part of a car purchase workflow a link on a web page may invite a customer to configure the desired car the customer wish's to purchase. This web link would, through the interactive API 201 and interactive node handler 206, initiate the appropriate process definition stored in the process repository 202. The interactive node 206 would then return a XML document to the customer to create the first page of the configure wizard (i.e. web page) via an XSL style sheet. Another example would be a link on a web page inviting a customer to add a selected product to a shopping basket. The interactive API 201 would determine whether a process definition has already been started (i.e. loaded into the process executor), if not it will initiate the shopping basket process.

After initiating the process, the process definition and associated process instance may have steps in it that require further information. This is achieved using interactive nodes 206, as described above.

The state of an active process instance (i.e. the execution of one particular process definition) can be tracked by asking for its state. An existing process instance can be located based upon an identification associated with the process instance. This process instance identification could be stored in the client apparatus, to allow the client/user to locate the process instance. Alternatively, the identification could be provided directly to a user.

The process instance can also maintain a list of milestones. The milestones can be obtained from an active process instance. This would allow the workflow initiator to identify how far the implementation of a workflow has got in terms of milestones.

A workflow can invoke sub-processes indirectly because a work node handler 207 can invoke a service, where the service could be another process instance, with it's associated process definition.

Having a process executor 203 for controlling the sequence of activity nodes executed and activity node handlers for initiating the execution of process, as described above, allows a user to extend the capabilities of a workflow without modification of the process executor 203. If a new activity node handler is made available, for example a timer node (not shown) that allows a user to set a time limit within a workflow, the new node type, which in this embodiment is incorporated as a software module, initiates a registration process with the process executor. The registration can be implemented using techniques well known to a person skilled in the art, for example as a software plug-in. This allows the process executor to recognise the new activity node type.

Accordingly, when the process executor 203 receives a process instance containing a process definition including a new activity node type the process executor 203 will follow the process definition arcs until the new activity node type is reached, on reaching the new node type the node definition, contained in the process instance and associated with this new type, is passed to the new activity node type to allow execution of the associated process.

As such, it is not necessary for the process executor 203 to understand the functionality of the new activity node type, the process executor 203 only needs to pass the node definition to the new activity node.

This means that node definitions pass through the process executor 203 transparently, allowing the easy extension of the workflow module 122 without modification of the process executor 203, as only the process definer and activity node handlers have to be modified to support a new node type.

Additionally, the activity node type information can be passed from the new node type to the process definition, via the process executor, to allow a user to develop new process definition incorporating the new activity node type.

As described above, an agent can access the workflow module 122 via the internet using an internet browser to interface with the interactive API 201. To accommodate the ability of an agent to move backwards and forwards through a sequence of web pages using a web browsers back and forward button the process executor 203 will identify out of sequence responses to an interactive node 206. This is achieved by the process executor 203 comparing received data from the agent with data that the process executor 203 would expect for the current interactive node. If the received data differs the process executor 203 determines, for example, by comparison with data expected from other interactive nodes included within the process definition.

If the process executor 203 identifies that there is an out of sequence response the process executor 203 will compensate the activity nodes from the current activity node back to the repeated node. The compensation of activity nodes is well known to a person skilled in the art and is described in U.S. Pat. No. 5,870,545.

Every node that can be reached from the repeated node and has been executed will be reset. For work nodes this means possible compensation and/or data resetting. For route nodes the process data will be reset. All nodes will be reset to their initial state.

This allows an agent to move backwards within a workflow and change input data, thereby allowing an agent to change their mind during the execution of a workflow.

As a process instance is being run the associated data (e.g. process definition) is stored in the process instance store 205 in XML format. The process executor 203 is arranged in response to a user's request to retrieve the associated process instance data. In this embodiment the data is encapsulated in XML template to allow the process instance to be executed by the process executor 203. However, the data can be encapsulated in any suitable executable form, for example HTML. This allows a process instance to be debugged by simulating a process instance and allowing modification of the XML document using the display 108 to display the results of the simulation of a process instance and the keyboard 106 to modify the XML document.

The simulation of a process instance can interpret or modify the process definition. The process definition can be supplied to a process executor to run through the steps, or the simulator can modify the document to represent the actions that are occurring.

The process executor is arranged to allow an agent to single step through a process instance. This means that when a process instance is loaded for execution, rather than processing as much as it can, the process executor will process one node (e.g. route node, work node) before returning to the agent.

What is claimed:

1. A computer apparatus for implementing a workflow, the workflow being defined by a sequence of activity nodes that include a plurality of interactive nodes, the computer apparatus comprising a processor for arranging and initiating the execution of the activity nodes in accordance with the defined sequence, wherein each interactive node is arranged to allow a user to input data for use in the execution of an activity node, the processor being arranged to analyse the user data to determine the interactive node in the sequence of activity nodes to which the data is associated.

2. A computer apparatus according to claim 1, wherein the processor being arranged, in response to the analyse, to initiate execution of the associated interactive node such that if the user data is associated with an interactive node that has been executed the interactive node is re-executed.

3. A computer apparatus according to claim 2, wherein the processor is arranged to compensate executed activity nodes that follow in the defined sequence from the re-executed interactive node.

4. A computer system comprising a computer apparatus according to claim 1 coupled, via a network, to a second computer apparatus, the second computer apparatus having a user interface to allow a user to input data for an interactive node.

5. A computer system according to claim 4, wherein the network is the internet.

6. A computer system according to claim 5, wherein the user interface is an internet application allowing sequential movement between web pages.

7. A method for implementing a workflow, the workflow being defined by a sequence of activity nodes that include a plurality of interactive nodes, the method comprising arranging and initiating the execution of the activity nodes in accordance with the defined sequence, wherein each interactive node is arranged to allow a user to input data for use in the execution of an activity node, and arranging to analyse the user data to determine the interactive node in the sequence of activity nodes to which the data is associated.

8. A method according to claim 7, further comprising initiating, in response to the analyse, the execution of the associated interactive node such that if the user data is associated with an interactive node that has been executed the interactive node is re-executed.

9. A method according to claim 8, further comprising compensating executed activity nodes that follow in the defined sequence from the re-executed interactive node.
